(19) United States
(12) Patent Application Publication
(10) Pub. No.: US 2008/0219467 A1
(43) Pub. Date: Sep. 11, 2008

(54) Systems, methods and articles that facilitating memorization and/or retention of information

(76) Inventors: Cynthia Robinson Mendoza, San Mateo, CA (US); Linda Arrillaga, Portola Valley, CA (US)

Correspondence Address: Andrew B. Schwaab, 2882 Greer Rd., Palo Alto, CA, 94303, US

(21) Appl. No.: 11/891,668

(22) Filed: Aug. 9, 2007

Related U.S. Application Data
(60) Provisional application No. 60/836,702, filed on Aug. 9, 2006.

(51) Int. Cl. H04B 3/00

(52) U.S. Cl. 381/77

(57) ABSTRACT

Systems, methods and articles are disclosed for facilitating memorization and/or retention of information. In one exemplary embodiment, there is provided a learning aid to assist memorizing information. The learning aid may include media containing machine-readable information used to disseminate audio communications to a user regarding a sequence of words to be memorized. The audio communications may include broadcast of the complete sequence of words, broadcast of portions of the sequence of words followed by periods of silence during which the user can repeat the recited portions, and additional audio broadcasts. Among other things, exemplary additional broadcasts can include one or more of sequences that require the user to complete the expression, periods of silence during which the user is encourage to practice reciting the words, and/or broadcast of the complete sequence such that the user may speak the complete sequence in unison with the broadcast.

### CROSS-REFERENCE TO RELATED APPLICATIONS

This application claims the benefit of priority to provisional application No. 60/836,702, all of the contents of which, as well as all of the Office submissions relating thereto, are incorporated herein by reference in entirety.

### APPENDIX MATERIALS

This application includes, as submitted herewith via preliminary amendment, three compact discs, as well as Appendix/Tab A, all of which are incorporated herein by reference in entirety.

### BACKGROUND

1. Field

The present invention relates to systems, methods and articles facilitating retention and/or memorization of information, and, inter alia, to systems, methods, learning aids, and machine/computer-readable articles that enable memorization of information such as words.

2. Description of Related Information

Existing systems, methods and articles for assisting with memorization of information and/or words sometimes include features that provide audio information or even encourage recitation of language by a listener. However, such items generally possess only limited benefit to or mundane repetition from the listener. They are unable to provide meaningful stimuli to a user or otherwise enable interaction having great efficacy regarding absorption, retention and/or memorization of information such as passages of words.

Thus, there is a need for systems, methods and articles that adequately enable users to, for example, receive salient audio information as well as participate and interact in a manner that effectively imprints the desired information.

### SUMMARY

Systems, methods and articles of manufacture consistent with this invention are directed to facilitating memorization and/or retention of information, such as sequences of words.

In one exemplary embodiment, there is provided a learning aid to assist memorizing information. The learning aid may include media containing machine-readable information used to disseminate audio communications to a user regarding a sequence of words to be memorized. The audio communications may include broadcast of the complete sequence of words, broadcast of portions of the sequence of words followed by periods of silence during which the user can repeat the recited portions, and additional audio broadcasts. Among other things, exemplary additional broadcasts can include one or more of sequences that require the user to complete the expression, periods of silence during which the user is encourage to practice reciting the words, and/or broadcast of the complete sequence such that the user may speak the complete sequence in unison with the broadcast.

It is to be understood that both the foregoing general description and the following detailed description are exemplary and explanatory only and are not restrictive of the invention, as described. Further features and/or variations may be provided in addition to those set forth herein. For example, the innovations herein may be directed to various combinations and subcombinations of the disclosed features and/or combinations and subcombinations of several further features disclosed below in the detailed description.

### DESCRIPTION OF THE DRAWINGS

The accompanying drawings, which constitute a part of this specification, illustrate various embodiments and aspects of the innovations herein and, together with the description, explain the principles of the invention. In the drawings:

FIG. 1 is a block diagram illustrating an exemplary system, method and/or article consistent with certain aspects related to the innovations herein;

FIG. 2 is a block diagram illustrating exemplary systems, methods and/or articles consistent with certain aspects related to the innovations herein;

FIG. 3 is a block diagram illustrating an exemplary system, method and/or article consistent with certain aspects related to the innovations herein;

FIG. 4 is a block diagram illustrating an exemplary system, method and/or article consistent with certain aspects related to the innovations herein; and

FIG. 5 is a block diagram illustrating exemplary systems, methods and/or articles consistent with certain aspects related to the innovations herein.

### DETAILED DESCRIPTION

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

Many techniques are employed in the effort to assist individuals in remembering or memorizing information such as passages of words. Examples of such techniques are those that inundate a listener with numerous iterations of the information, as well as those that elicit the listener to engage in mundane repetition of the information.

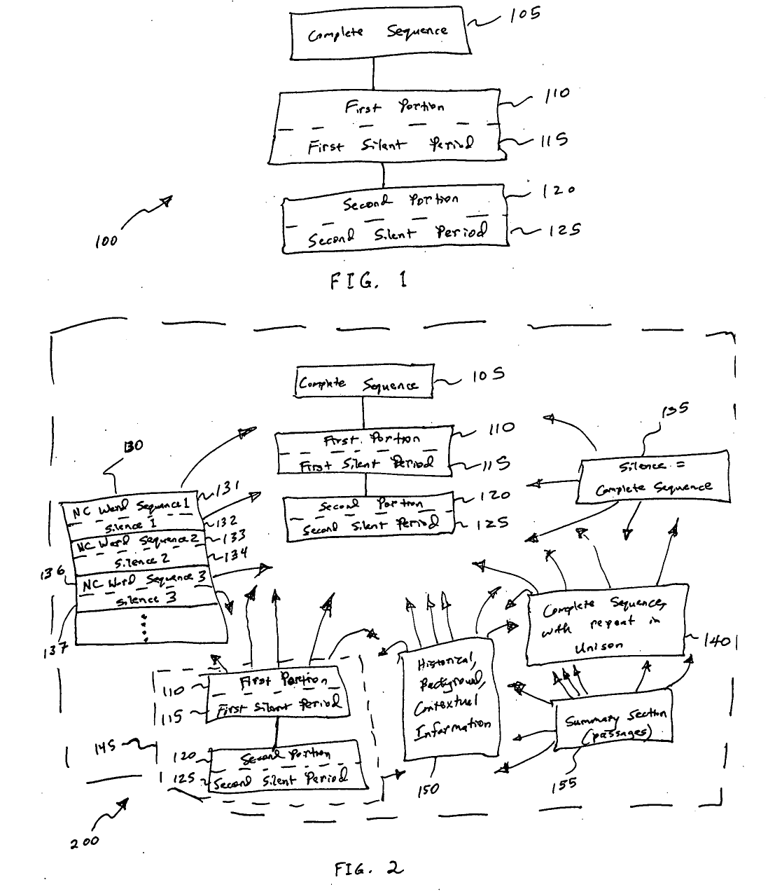

FIG. 1 is a block diagram illustrating an exemplary broadcast sequence 100 consistent with certain aspects related to the innovations herein. The broadcast sequences and methodologies shown and discussed throughout may be implemented as or in systems and methods, as well as via various articles of manufacture, such as those including diverse media (e.g., electronic, such as portable memory devices, etc., optical, such as on optical discs or devices, CDs, DVDs, etc., in addition to any additional magnetic or other media elements, etc.) and/or storage components. For example, such broadcast sequences may be implemented as a method. By way of another example, such broadcast sequences may be stored on a media component as electronically- or optically-coded instruction for a processor to implement the broadcast sequence on an associated processing, computing, audio, or audiovisual device. Examples of such media components are devices comprising flash memory (memory cards, mobile phones, MP3 players, etc.) and/or articles wherein the instruction for broadcast are accessed via optical means, such as CDs, DVDs, DVRs, etc. This media component may, in turn, be package with or constitute a learning aid, such as an MP3 device or audio CD, in addition to other physical elements, that implement one or more features set forth herein. As such, one or more exemplary articles may comprise machine-readable media containing machine-readable information that provides instruction to a processor for disseminating information to the user regarding words to be memorized, this machine-readable information including instructions for broadcast sequences (i.e., dissemination of audio information) as set forth herein.

These articles may also be packaged with other physical elements that facilitate memorization and/or retention of the subject information. For example, cards, placards or other indicia-bearing elements may be include to provide addition visual and physical memorization queues for the user. Such mementos can be, for example, cards (separated, perforated, etc.) included within the packaging of the article. Additionally, such mementos may also take the form of discrete items, each associated with a different piece of information or passage of words being broadcast. Further, such mementos can include historical, background, and/or contextual information concerning the information or aspects of the information that assist the user in memorizing the information.

Referring to FIG. 1, exemplary broadcast sequence 100 may comprise information including broadcasting recitation of a complete sequence 105 of information (e.g., words to be memorized, etc.), as well as broadcasting recitations of portions of the words from this complete sequence (or passage, i.e., of words to be memorized). Broadcasting recitation of a complete sequence 105 of information typically enables familiarization of the user with the full sequence of information, regarding which the user's attention will be focused during ensuing steps. In addition, broadcasting recitation of portions of the words from the complete sequence may also be employed. According to one example of such apportioned broadcasting, the complete sequence might be broken up into two or more parts. (The number of parts may depend on the length of the complete sequence; if it is quite short, only one part may be necessary.) The examples addressed herein discuss two parts or portions, though of course any number of such portions may be employed. In the exemplary two-part implementation, here, the associated apportioned broadcasting process would include broadcasting recitation of a first portion of the words 110, broadcasting a first silent period 115 having a duration of time commensurate with a time period required to speak/repeat the first portion of the words, broadcasting recitation of a second portion of the words 120, and broadcasting a second silent period 125 having a duration of time commensurate with a time period required to speak/repeat the second portion of the words. Again, additional apportionment may certainly be implemented in this regard, especially if the complete sequence is a longer sequence of information or words. Furthermore, additional memorization steps may be implemented in connection with the above broadcast sequence 100, as set forth in more detail below by example.

FIG. 2 illustrates a variety of exemplary broadcast sequences 200 as well as some interrelationships between the subcomponents thereof. FIG. 2 shows the broadcast sequence 100 of FIG. 1 (subcomponents 105-125), as well as a variety of additional subcomponents that may be implemented with or without the subcomponents illustrated in FIG. 1. Additional subcomponents of FIG. 2 include one or more non-completed word sequence subcomponent 130, one or more silence for the duration of the complete sequence subcomponent 135, one or more broadcasting the complete sequence for repetition in unison subcomponents 140, one or more supplemental apportioned broadcasting process subcomponents 145, one or more contextual broadcasting subcomponents 150, and/or one or more summary broadcasting subcomponents 155. These subcomponents may be inserted and/or interrelated with other components and subcomponents as shown via the arrows in FIG. 2. Various permutations of these additional subcomponents 130, 135, 140, 145, 150, 155 may also be implemented, separately or together, in connection with the memorization broadcast sequences disclosed throughout this written description. Specific examples set forth below show how various subcomponents may be fit together to create cohesive broadcast sequences that interrelate in logical series or steps of user comprehensibility, for example, from more basic steps, to steps facilitated by knowledge from earlier steps, to culmination/summarization-type steps.

Additional, exemplary detail concerning the broadcast sequence subcomponents of FIG. 2 is as follows. For example, with regard to the non-completed word sequence subcomponent 130, or “fill in the blanks” subcomponent, an associated method, system or article may include a plurality of non-completed word sequences 131, 133, 136, with a corresponding number of silent periods 132, 134, 137 each associated a respective sequence 131, 133, 136. This subcomponent is characterized by broadcast of portions or complete sequences of the words to be memorized, but with each broadcast having one or more words missing (i.e., absent/not spoken) and, in its place, a period of silence commensurate in duration with the missing word or words. Broadcast of this subcomponent may be prefaced with a communication that the user should attempt to insert (speak) the missing word or words at the point in the broadcast when the commensurate period of silence occurs. This memorization feature may assist the user in focusing on important words or concepts; further, it may be useful to assist the user in general retention of the information at earlier times in a memorization broadcast sequence. For example, a user with limited exposure to the information or words may not be able to repeat the complete sequence or even longer portions thereof, hence this technique helps familiarize the user at such earlier time(s). As shown in FIG. 2, an exemplary non-complete word sequence subcomponents 130 may include a first non-complete word sequence 131 and an associated first silence 132 that may take the form of one or more silent periods during the broadcast of the first non-complete word sequence 131. The non-complete word sequence subcomponents 130 may then include a second non-complete word sequence 133 and an associated second silence 134. Further, the non-complete word sequence subcomponents 130 may include a third non-complete word sequence 136 and an associated third silence 137, as well as fourth, fifth, etc., additional sequences and silences, as applicable.

Regarding the ‘silence for the duration of the complete sequence’ subcomponent 135 shown in FIG. 2, this subcomponent may be prefaced with a communication to the user that he or she should speak the complete sequence during the silence. This subcomponent's exemplary functionality is broadcast of a period of silence of a duration of time commensurate with a time period required to speak the complete sequence, during which silence the user is encouraged to speak/recite the complete sequence. Inter alia, this feature can facilitate practice of the complete sequence, enable awareness of how much or how little of the complete sequence the user has assimilated, etc.

Regarding an exemplary ‘broadcasting the complete sequence for repetition in unison’ subcomponent 140, as shown in FIG. 2, this subcomponent may be prefaced with a communication indicating that the user should speak the complete sequence in unison with the another broadcasting of the complete sequence. This subcomponent's exemplary functionality is broadcast of the complete sequence of information (e.g., words to memorize, etc.) while encouraging the user to speak/repeat the complete sequence in unison with the broadcast thereof.

Exemplary supplemental apportioned broadcasting process subcomponent 145, as shown in FIG. 2, performs supplemental functionality akin to the apportioned broadcasting set forth in connection with FIG. 1. Regarding this subcomponent, for certain information and passages, it may be even more helpful to repeat the apportioned broadcasting 110, 115, 120, 125 performed previously, or to broadcast another apportioned series of the information (e.g., with differing apportionment).

Regarding an exemplary contextual broadcasting subcomponent 150, as shown in FIG. 2, an associated method, system or article includes broadcasting contextual information concerning the information or words to be memorized. This contextual information can include historical information, background information, commentaries, summaries of commentaries or commentary information and/or any other type of information useful to provide a context that may enable the user to assimilate and retain the information or words to be memorized. In addition to giving contextual information to help the user, the features of location and duration of the broadcast of this subcomponent also factor into its benefit(s) to the user. This broadcast of contextual information is helpful, for example, at strategic locations throughout an overall broadcast sequence. For example, placement just before or just after an initial complete sequence of information 105 may help a user better associate or familiarize himself or herself with the information to be memorized. Placement during the body of a broadcast sequence, especially a longer one, may also assist in stimulating the user and enabling better retention. Further, placement between differing passages of information or introducing related groups of passages, may also assist in providing the user with beneficial contextual information to help learn and retain the desired information. The duration of the contextual broadcast is also a consideration that may contribute to better memorization of information. Some exemplary periods of time found to be beneficial in this regard is from about 1 minute to about 5 minutes, from about 2 minutes to about 4 minutes, as well as from about 12 minutes to about 20 minutes (i.e., when introducing larger, overall concepts that, for example, encapsulate an entire series/passages of broadcast information).

With regard to an exemplary summary broadcasting subcomponent 155, as shown in FIG. 2, an associated method, system or article may include broadcast of a summary of two or more pieces of information (e.g., word sequences, passages, etc.) to be memorized. According to aspects of this subcomponent, the summary may be located at the completion of broadcast of all of the broadcast sequences associated with the pieces of information. Alternately, a summary may be located at the beginning of a series or sequence of such pieces of information. Such summary serves to reinforce the information to be retained and provide the user with an additional stimuli to help retain all of the information. This subcomponents is especially helpful for memorization of a series of related pieces of information or passages. Receiving broadcast of a summary of such related information may provide the user with additional interrelationship information or keys to memorization and otherwise facilitate retention.

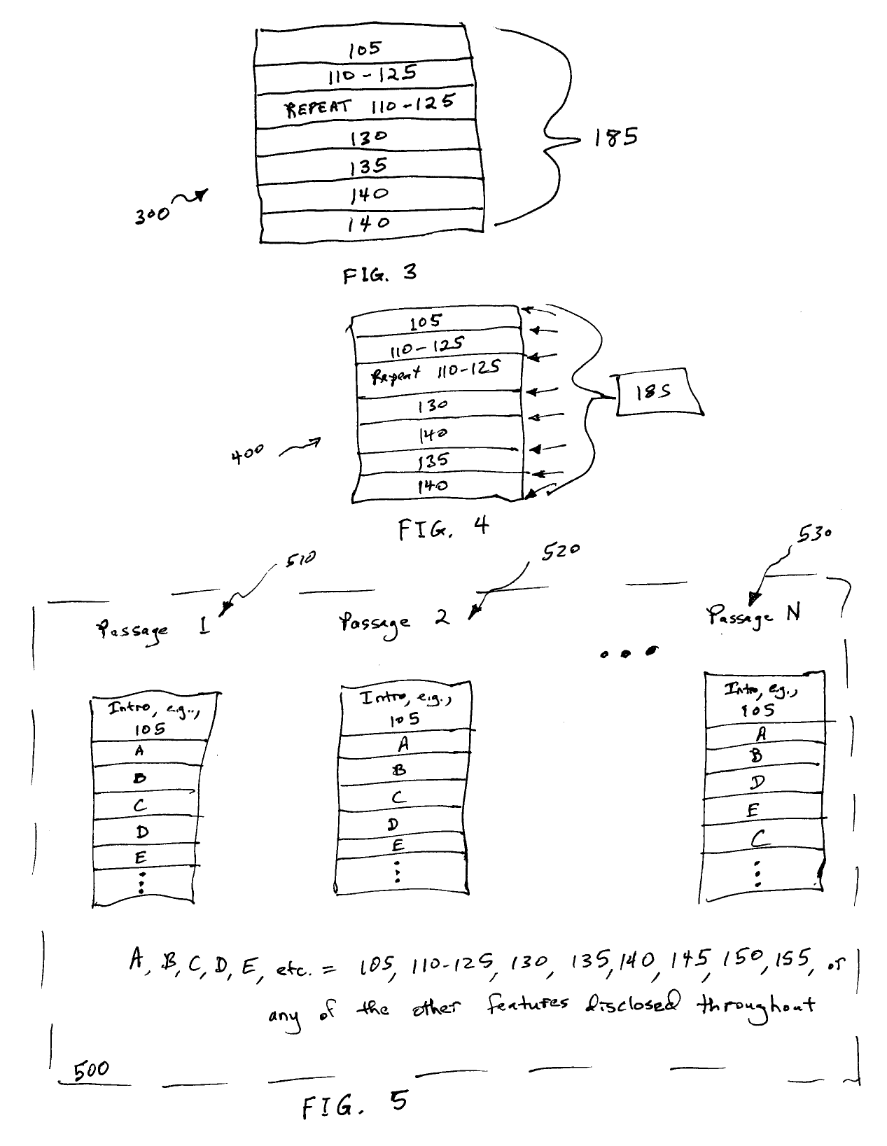

FIG. 3 is a block diagram illustrating an exemplary broadcast sequence 300 consistent with certain aspects related to the innovations herein. Vis-à-vis the concepts set forth above, exemplary broadcast sequence 300 includes broadcasting recitation of a complete sequence 105, an apportioned broadcasting sequence 110, 115, 120, 125, a supplemental or repeated apportioned broadcasting sequence 110, 115, 120, 125, a non-completed word sequence 130, a ‘silence for the duration of the complete sequence’ subcomponent 135, as well as broadcasting the complete sequence for repetition in unison 140, which is then repeated a second time. FIG. 3 also illustrates another exemplary aspect, general communication 185. General communication may be broadcast information that is relevant to the information presented or the learning process, more generally. For example, general information 185 may be instructions to the user as to how they may interact, information concerning the next phase of the broadcast sequence, etc. As shown in FIG. 3, general information may be inserted at any or all of the various indicated points of the broadcast.

FIG. 4 is a block diagram illustrating an exemplary broadcast sequence 400 consistent with certain aspects related to the innovations herein. Again, vis-à-vis the concepts set forth above, exemplary broadcast sequence 400 includes broadcasting recitation of a complete sequence 105, an apportioned broadcasting sequence 110, 115, 120, 125, a supplemental or repeated apportioned broadcasting sequence 110, 115, 120, 125, a non-completed word sequence 130, a broadcasting the complete sequence for repetition in unison subcomponent 140, a ‘silence for the duration of the complete sequence’ subcomponent 135, as well as another broadcasting the complete sequence for repetition in unison subcomponent 140. AS with FIG. 3, this exemplary sequence may also employ general communication 185 to the user.

The broadcast sequences set forth above, as well as those set forth in the appendix materials, have been successful, popular, and/or lauded for their efficacy, especially in connection with memorization of Bible verses. In that regard, as with any other information having alphanumeric reference information, such reference information may also form a part of the information (passages) that are broadcast to and/or repeated by the user.

FIG. 5 is a block diagram illustrating exemplary overall broadcast sequence 500 associated with systems, methods and/or articles consistent with certain aspects related to the present innovations. As shown in FIG. 5, several pieces of information or passages may be cascaded using the techniques set forth herein. For example, overall broadcast sequence 500 may include broadcasting directed to a first passage 510, broadcasting associated with a second passage 520, as well as, optionally, broadcasting associated with any number of addition passages 530. Each passage 510, 520, 530 may introduced by means of an introductory section, which may be, by way of one example, broadcasting recitation of a complete sequence of words to be memorized 105. In another exemplary alternative, each passage may be introduced with contextual information 150. Regardless of introduction, a sequence of subcomponents is then used to best inundate the user with the passages and associated information. As indicated in the examples above, a series of passages such as this may be introduced with contextual information. Further, various permutations of subcomponents may be used for each differing series of passages, and/or different passages within one series may also use different permutations of subcomponents, as shown in FIG. 5 (compare, for example, the second passage 520 with passage N 530).

As disclosed herein, embodiments and features of the invention may be implemented through machine- or computer-media, computer-hardware, software and/or firmware. For example, the systems and methods disclosed herein may be embodied in various forms including, for example, a data processor, such as a computer that also includes media, a database, digital or other storage, digital electronic circuitry, firmware, software, or in combinations of them. Further, while some of the disclosed implementations describe source code editing components such as software, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the invention or they may include a general-purpose computing device, computer or computing platform selectively activated or reconfigured by code to provide the necessary functionality. The processes disclosed herein are not inherently related to any particular media, computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage medium or element or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

It is to be understood that the foregoing description is intended to illustrate and not to limit the scope of the invention, which is defined by the scope of the appended claims. Other embodiments are within the scope of the following claims.

What is claimed is:

1. A learning aid that enables a user to memorize information, the learning aid comprising:
an article comprising machine-readable media containing machine-readable information that provides instruction to a processor for disseminating information to the user regarding words to be memorized, the machine-readable information including instructions for disseminating audio information comprised of:
broadcasting recitation of a complete sequence of the words to be memorized;
broadcasting recitation of a first portion of the words;
broadcasting a first silent period having a duration of time commensurate with a time period required to speak/repeat the first portion of the words;
broadcasting recitation of a second portion of the words; and
broadcasting a second silent period having a duration of time commensurate with a time period required to speak/repeat the second portion of the words.

2. The learning aid of claim 1, wherein the audio information further comprises:
broadcasting a series of non-completed word sequences, each word sequence characterized by a missing word, along with periods of silence broadcast in place of the missing words, wherein each period of silence is of a duration of time commensurate with a time period required to speak the missing word.

3. The learning aid of claim 1, wherein the audio information further comprises:
broadcasting a period of silence of a duration of time commensurate with a time period required to speak the complete sequence, prefaced with a communication indicating that the user should speak the complete sequence during the silence.

4. The learning aid of claim 1, wherein the audio information further comprises:
broadcasting a recitation of the complete sequence, prefaced with a communication indicating that the user should speak the complete sequence in unison with the broadcasting of the complete sequence.

5. The learning aid of claim 1, wherein the audio information further comprises:
broadcasting recitation of the first portion of the words;
broadcasting the first silent period;
broadcasting recitation of the second portion of the words; and
broadcasting the second silent period.

6. The learning aid of claim 4, wherein the audio information further comprises:
broadcasting another recitation of the complete sequence, prefaced with a communication indicating that the user should speak the complete sequence in unison with the another broadcasting of the complete sequence.

7. The learning aid of claim 1, wherein the audio information further comprises:
broadcasting recitation of historical/background/contextual information regarding the words.

8. The learning aid of claim 7, wherein the historical/background/contextual information is broadcast for a period of time from about 1 minute to about 20 minutes.

9. The learning aid of claim 7, wherein the historical/background/contextual information is broadcast for a period of time from about 1 minute to about 5 minutes, from about 2 minutes to about 4 minutes, or from about 12 minutes to about 20 minutes.

10. The learning aid of claim 1, wherein the machine-readable information provides instruction to disseminate a plurality of discrete passages of words, and wherein the audio information further comprises a summary of all the plurality of discrete passages of words.

11. The learning aid of claim 10, wherein the summary is provided for pluralities of passages of words in quantity from about 2 to about 6.

12. The learning aid of claim 1, wherein the words are Bible words.

13. The learning aid of claim 1, wherein the audio information further comprises:
the audio information of claim 5, broadcast following the audio information of claim 1, wherein the audio information of claim 1 is broadcast sequentially as listed in claim 1;
the audio information of claim 2, broadcast following the audio information of claim 5;
the audio information of claim 3, broadcast following the audio information of claim 2;
the audio information of claim 4, broadcast following the audio information of claim 3; and
following the audio information of claim 4, broadcasting another recitation of the complete sequence, prefaced with a communication indicating that the user should speak the complete sequence in unison with the broadcast of the complete sequence.

14. The learning aid of claim 13, wherein the audio information further comprises:
providing historical/background/contextual information regarding the words.

15. The learning aid of claim 1, wherein the audio information further comprises:
the audio information of claim 5, broadcast following the audio information of claim 1, wherein the audio information of claim 1 is broadcast sequentially as listed in claim 1;
the audio information of claim 2, broadcast following the audio information of claim 5;
the audio information of claim 4, broadcast following the audio information of claim 3;
the audio information of claim 3, broadcast following the audio information of claim 2; and
following the audio information of claim 3, broadcasting another recitation of the complete sequence, prefaced with a communication indicating that the user should speak the complete sequence in unison with the broadcast of the complete sequence.

16. A method of facilitating memorization of information comprising:
broadcasting recitation of a complete sequence of the words;
broadcasting recitation of a first portion of the words;
broadcasting a first silent period having a duration of time commensurate with a time period required to speak/repeat the first portion of the words;
broadcasting recitation of a second portion of the words;
broadcasting a second silent period having a duration of time commensurate with a time period required to speak/repeat the second portion of the words;
broadcasting a sequence of incomplete segments of the words, each incomplete segment characterized by a missing word, along with periods of silence broadcast in place of the missing words, wherein each period of silence is of a duration of time commensurate with a time period required to speak the missing word.

17. The method of claim 16, further comprising one or both of:
broadcasting a recitation of the complete sequence, prefaced with a communication indicating that the user should speak the complete sequence in unison with the broadcast of the complete sequence; and/or
broadcasting a period of silence of a duration of time commensurate with a time period required to speak the complete sequence, prefaced with a communication indicating that the user should speak the complete sequence during the silence.

18. The method of claim 17, wherein the method includes both steps recited in claim 17, and wherein the step of broadcasting a period of silence occurs after the step of broadcasting a sequence of incomplete segments, and the step of broadcasting a recitation of the complete sequence occurs after the step of broadcasting a period of silence.

19. An article comprising machine-readable media containing machine-readable information that provides instruction to a processor for disseminating information to a user regarding words to be memorized, the machine-readable information including instructions for disseminating audio information comprised of:
broadcasting recitation of a complete sequence of the words to be memorized;
broadcasting recitation of a first portion of the words;
broadcasting a first silent period having a duration of time commensurate with a time period required to speak/repeat the first portion of the words;
broadcasting recitation of a second portion of the words; and
broadcasting a second silent period having a duration of time commensurate with a time period required to speak/repeat the second portion of the words.

20. An article having machine readable media containing machine-readable information regarding information to be memorized, the machine-readable information providing instruction to a processor that enables operation of the machine for:
broadcasting recitation of a complete sequence of the words to be memorized;
broadcasting recitation of a first portion of the words;
broadcasting a first silent period having a duration of time commensurate with a time period required to speak/repeat the first portion of the words;
broadcasting recitation of a second portion of the words; and
broadcasting a second silent period having a duration of time commensurate with a time period required to speak/repeat the second portion of the words.

21. The learning aid of claim 1, wherein the audio information further comprises:
following the broadcasting recitation of the complete sequence, broadcasting recitation of historical/background/contextual information regarding the words.

22. The learning aid of claim 21, wherein the historical/background/contextual information is broadcast for a period of time from about 1 minute to about 5 minutes.
